(19) United States
(12) Patent Application Publication
(10) Pub. No.: US 2015/0206271 A1
(43) Pub. Date: Jul. 23, 2015

(54) SYSTEM AND METHOD FOR INCREASING A GRAPHICS PROCESSING CAPABILITY OF A MOBILE DEVICE

(71) Applicant: Nvidia Corporation, Santa Clara, CA (US)

(72) Inventors: Mathias Schott, Santa Clara, CA (US); Mehmet Cebenoyan, Santa Clara, CA (US)

(73) Assignee: Nvidia Corporation, Santa Clara, CA (US)

(21) Appl. No.: 14/161,079

(22) Filed: Jan. 22, 2014

(51) Int. Cl. G06T 1/20; G09G 5/36; G06T 1/60

(52) U.S. Cl. CPC G06T 1/20; G06T 1/60; G09G 5/363; G09G 2370/02; G09G 2360/06

(57) ABSTRACT

A system for, and method of, increasing a graphics processing capability of a mobile device and a mobile device incorporating the system or the method. In one embodiment, the system includes: (1) a graphics application programming interface (API) operable to cause a graphics processing resource of the mobile device to render data generated by an application to yield rendered data and (2) a network interface associated with the mobile device and operable to: (2a) transmit at least some of the rendered data via a network link for postprocessing to yield postprocessed data and (2b) receive the postprocessed data for display on the mobile device.

### TECHNICAL FIELD

This application is directed, in general, to graphics processing and, more specifically, to a system and method for increasing the graphics processing capability of a mobile device.

### BACKGROUND

Mobile devices such as cell phones, smartphones, pads and tablets are ubiquitous. While they were originally introduced to provide rudimentary functionality, such as telephony and text messaging, they have now evolved to the point that they have begun to replicate the functions of physically much larger computers, such as desktop personal computers. Accordingly, mobile devices are beginning to be used for gaming, desktop publishing and graphics and video editing. These are particularly computation—and graphics-intensive applications, and test the general—and special-purpose processing and storage limits of mobile devices.

Supporting the ever-intensifying use of mobile devices is an evermore-capable wireless network infrastructure, making its presence known in both cellular and wireless Internet access (Wi-Fi) forms. Together with Bluetooth®, which provides relatively short-range wireless connectivity, mobile devices are able to make higher-bandwidth, more reliable wireless connections in more places than ever before possible.

### SUMMARY

One aspect provides a system for increasing a graphics processing capability of a mobile device. In one embodiment, the system includes: (1) a graphics application programming interface (API) associated with the mobile device and operable to cause a graphics processing resource of the mobile device to render data generated by an application to yield rendered data and (2) a network interface associated with the mobile device and operable to: (2a) transmit at least some of the rendered data via a network link for postprocessing to yield postprocessed data and (2b) receive the postprocessed data for display on the mobile device.

Another aspect provides a method of increasing a graphics processing capability of a mobile device. In one embodiment, the method includes: (1) rendering data in the mobile device to yield rendered data, (2) transmitting at least some of the rendered data via a network link for postprocessing to yield postprocessed data, (3) receiving the postprocessed data via the network link and (4) displaying an image on the mobile device using the postprocessed data.

Yet another aspect provides a mobile device. In one embodiment, the mobile device includes: (1) a display, (2) a central processing unit (CPU), (3) a graphics processing unit (GPU) having a graphics API operable to cause the GPU to render data generated by an application executing on the CPU to yield rendered data and (4) a network interface operable to: (4a) transmit at least some of the rendered data via a network link for postprocessing to yield postprocessed data and (4b) receive the postprocessed data for display on the display.

### BRIEF DESCRIPTION

Reference is now made to the following descriptions taken in conjunction with the accompanying drawings, in which:

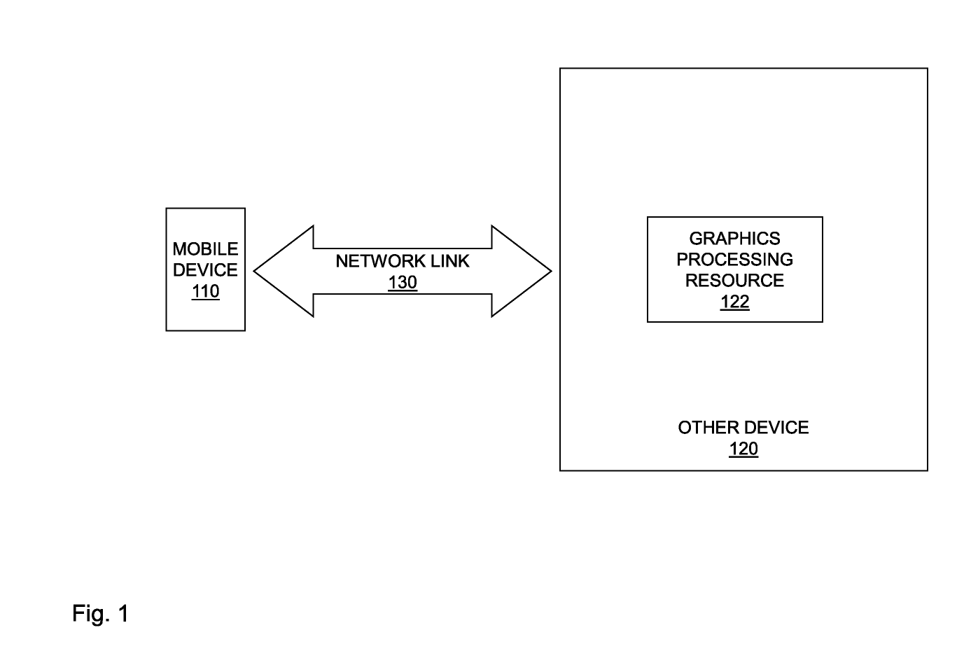

FIG. 1 is a block diagram of one embodiment of a network in which a system or method for increasing the graphics processing capability of a mobile device may be carried out;

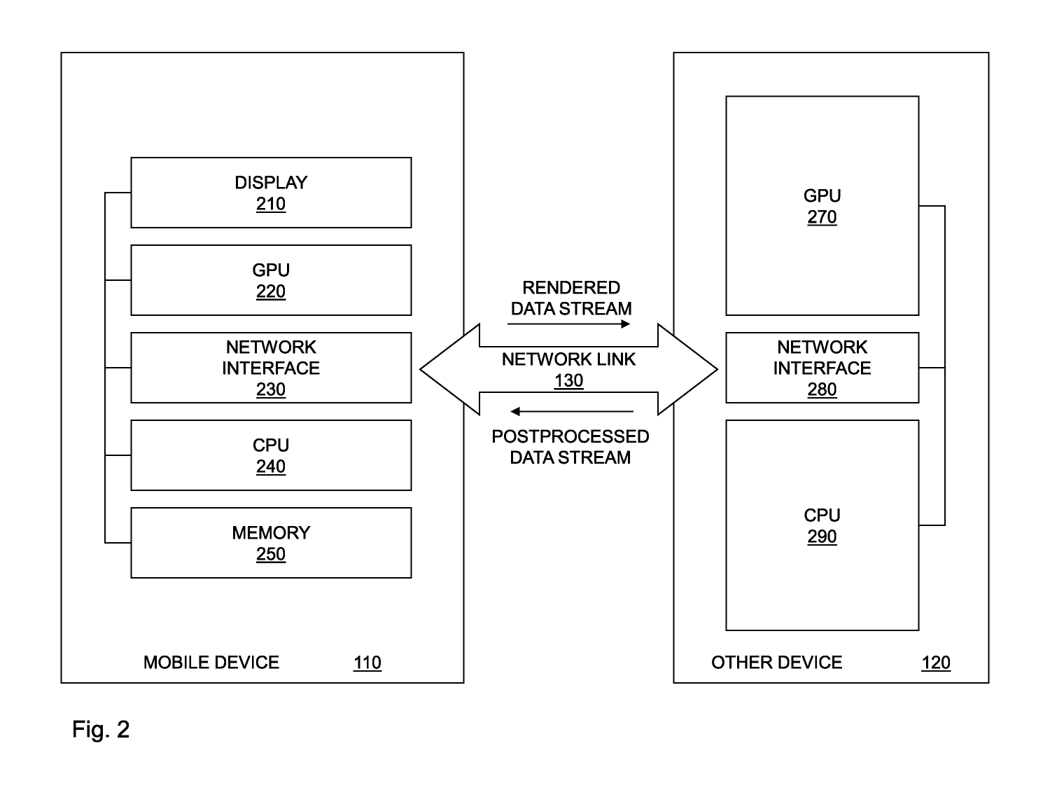

FIG. 2 is a block diagram of one embodiment of a system for increasing the graphics processing capability of a mobile device; and

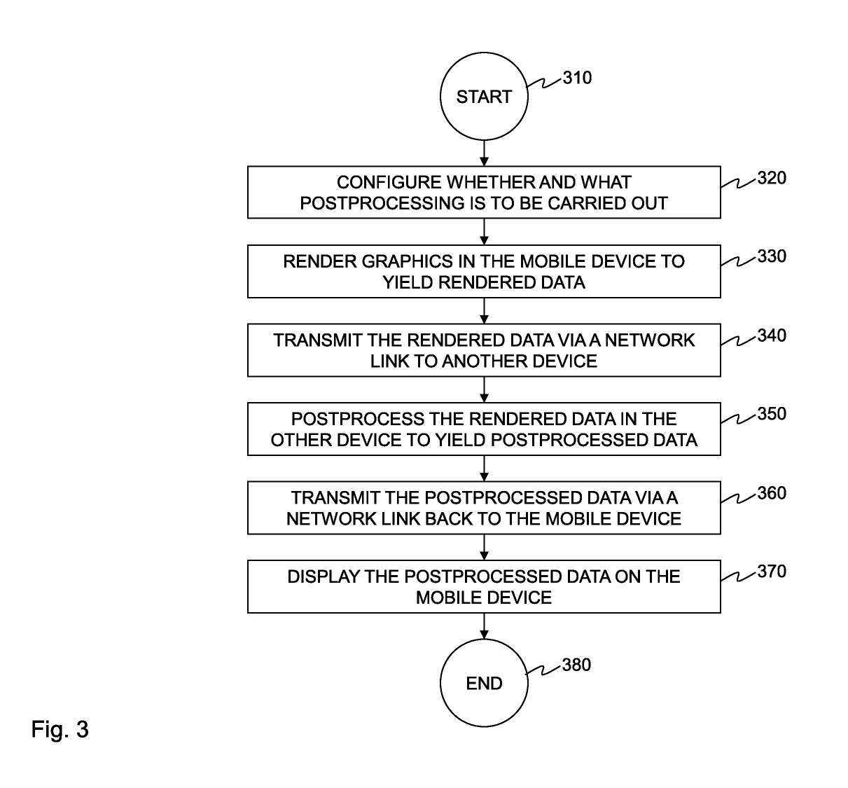

FIG. 3 is a flow diagram of one embodiment of a method of increasing the graphics processing capability of a mobile device.

### DETAILED DESCRIPTION

Nvidia Corporation has made commercially available a novel mobile device, namely a handheld gaming console called Shield™. Shield™ features a high-resolution touchscreen, joysticks, a directional pad (D-pad) and various hardware buttons that a player may use to play a video game. Shield™ uses Android as its operating system (OS), is wireless network-enabled and is powered by Nvidia's Tegra® 4 processor.

Through Nvidia's GameStream™ suite, Shield™ allows the streaming of games executing on a desktop PC. Shield™ also supports a “console mode,” which allows it to be connected to a television or monitor (either using a wireless connection or Universal Serial Bus, or USB) and controlled with a Bluetooth® controller, and software for mapping on-screen control buttons to its hardware buttons for Android games which do not natively support them. Shield™ is able to download games and other apps from Google® Play™, as with most other Android®-based devices.

As stated above, the more-capable mobile devices, such as smartphones, tablets and mobile game consoles are coming into wide use for gaming, desktop publishing and graphics and video editing. However, it is realized herein that their limited size and battery capacity limit their graphics processing capability. It is realized herein that such devices would benefit from access to network-based graphics processing resources.

As those skilled in the pertinent art are aware, more sophisticated graphics processing is generally performed in two phases. The first phase is rendering, which involves evaluating the interaction between light and various objects in a three-dimensional (3D) object space (also called a world space or game space) as seen from a viewpoint. Rendering results in a two-dimensional (2D) screen space represented a frame buffer typically having multiple components contained in subordinate buffers, such as geometry, depth, color and stencil buffers, that together make up a frame buffer.

The second phase is postprocessing, in which one or more of the subordinate buffers constituting the screen space is manipulated by shaders in various ways to produce some visual effect, often to make the resulting images more realistic or otherwise appealing. Many postprocessing effects exist. Notable ones include screen space ambient occlusion (SSAO), screen space global illumination (SSGI), screen space anti-aliasing (SSAA), tone mapping with eye adaptation, color modifying, motion blurring, light blooming, sharpening, sun-ray enhancing, depth-of-field adjusting and edge detecting. The pipelines of modern GPUs are designed to carry out both rendering and postprocessing efficiently and in parallel to the extent possible. After postprocessing, the subordinate buffers are merged, and the frame buffer is displayed.

It is realized herein that the rendering and postprocessing phases differ from one another in at least one salient respect: rendering involves extensive interaction with the application (e.g., game) that is creating the object space being rendered, while postprocessing is typically carried out without such interaction. It is further realized herein that, in considering how graphics processing may be augmented using network-based graphics processing resources, this distinction could be important.

It is realized herein that graphics processing may in fact be augmented by carrying out rendering locally (i.e. in the same mobile device in which the application creating the object space is executing), but carrying out the postprocessing using a network-based graphics processing resource. More specifically, it is realized herein that the subordinate buffers containing the rendered, screen-space output can be communicated over a network to a remote GPU, postprocessed and perhaps then communicated back to the mobile device for display.

It is realized that, while any network-based graphics processing resource may be employed in such a manner, network-based graphics processing resources that are relatively close from a routing perspective are particularly advantageous, since network latency and jitter are relatively low. It is specifically realized that the network-based graphics processing resource most amenable to a delegation of postprocessing is likely to be a GPU of a desktop computer located close to the mobile device, such that a one- or two-hop network connection (i.e., such as may be achievable using Bluetooth®, Wi-Fi Direct or a home area network, or HAN) may be established.

It is further realized that, because postprocessing can be carried out independently (without interacting with the application creating the object space with which the postprocessing is associated), recent, effective postprocessing techniques may employed to enhance the images produced by legacy applications, such as old games, without having to modify the applications. It is yet further realized that a driver may be employed to allow remote postprocessing to be carried out in a manner that is transparent to the application.

Accordingly, introduced herein are various embodiments of a system and method for increasing the graphics processing capability of a mobile device in which, while graphics rendering is carried out locally in the mobile device, graphics postprocessing is delegated to network-based graphics processing resources.

A few examples will illustrate why increasing the graphics processing capability of a mobile device can be advantageous. In a first example, the user of the mobile device 110 may be playing a game that offers enhanced visual effects involving postprocessing. However, invoking the required postprocessing slows the response of the game down to the point that gameplay is hampered. With the benefit of the system or method introduced herein the user can cause the mobile device 110 to be networked to the other device 120, and the postprocessing can be offloaded to the GPU 290 of the other device. In a second example, the user of the mobile device 110 may be playing a legacy (i.e. relatively old) game that does not even accommodate enhanced visual effects involving postprocessing; the game has no mechanism for choosing them. The user can, through the system and method disclosed herein, select one or more postprocessing effects to be carried out. Then, in a manner that is “transparent” to the game, its rendered graphics are communicated to the GPU 290 of the other device 120 for postprocessing then returned to the mobile device 110 for display. Legacy games may thus be given a new lease on life, allowing the images they produce to look better (e.g., more realistic) than originally intended or possible.

Having described various embodiments in general terms and highlighted some examples of how increasing the graphics processing capability of a mobile device may be advantageous, certain embodiments of the system and method introduced herein will now be described.

FIG. 1 is a block diagram of one embodiment of a network in which a system or method for increasing the graphics processing capability of a mobile device 110 may be carried out. The network encompasses the mobile device 110 and another device 120, which, in the illustrated embodiment, is a personal computer (PC). In one specific embodiment, the PC is a desktop PC.

A network link 130 allows communication between the mobile and other devices 110, 120. The network link 130 may have one or more wired or wireless segments. However, in the illustrated embodiment, the network link 130 has at least one wireless segment and relatively few hops (e.g., such as may be achieved using Bluetooth, Wi-Fi Direct or a HAN). While not necessary, a network link 130 having relatively few hops typically exhibits reduced latency and jitter, which is advantageous in maintaining a desired flow of data between the mobile device 110 and the other device 120.

FIG. 2 is a block diagram of one embodiment of a system for increasing the graphics processing capability of a mobile device. The mobile device 110 has a display 210, a GPU 220, a network interface 230, a CPU 240 and memory 250. An unreferenced bus couples the display 210, the GPU 220, the network interface 230, the CPU 240 and the memory 250 together for communication thereamong. Other embodiments may employ multiple buses to interconnect the display 210, the GPU 220, the network interface 230, the CPU 240 and the memory 250.

Though the other device 120 may have additional components such as a display and memory, FIG. 2 illustrates a GPU 270, a network interface 280 and a CPU 290. An unreferenced bus couples the GPU 270, the network interface 280 and the CPU 290 together for communication thereamong. Other embodiments may employ multiple buses to interconnect the GPU 270, the network interface 280 and the CPU 290.

Although not always the case, the mobile device 110 will be assumed to be less capable in terms of graphics processing capability than the other device 120. In the context of FIG. 1, it will be presumed that this disparity stems from the fact that the GPU 220 is suited for a battery-powered, mobile device. For example, the mobile device 110 may have a Tegra® GPU, commercially available from Nvidia Corporation of Santa Clara, Calif. Such GPUs tend to be of lower computational capability than GPUs designed for devices that stay coupled to the commercial power grid while they operate, such as desktop PCs or servers, because power consumption is of relatively little concern in the latter. In contrast, the GPU 270 of the other device 120 is significant. For example, the other device 120 may be a desktop PC having a GeForce GTX® Titan® GPU, also commercially available from Nvidia Corporation.

It should be noted that, though the mobile device 110 is less capable in terms of graphics processing capability than the other device 120, it is at least somewhat capable of rendering graphics. Mobile devices lacking a GPU tend to employ their CPU to render graphics. While far slower and less efficient, a CPU certainly can render graphics.

In the context of FIG. 2, applications executing on the CPU 240 and processing data that is stored, at least to some extent, in the memory 250 will be afforded the benefit of access to the graphics processing resources of the other device 120, namely its GPU 290, for the purpose of carrying out postprocessing. In certain embodiments, the applications executing on the CPU 240 do not require modification to be afforded this benefit.

In operation, an application (not shown) executing on the CPU 240 and using the memory 250 for storage and the GPU 220 for graphics processing generates and manipulates objects that will eventually be displayed on the display 210. In the illustrated embodiment, the application makes calls to a graphics application programming interface (API) (not shown, but associated with the GPU 220). The calls made through the graphics API prompt the GPU 220 to render graphics for the application. It is assumed that, in carrying out the rendering, the GPU 220 produces a stream of data stored in one or more subordinate buffers, including, e.g., geometry, depth, color and stencil buffers. Those skilled in the pertinent art understand graphics rendering, how these one or more subordinate buffers are generated as a result of rendering, and what these subordinate buffers may contain.

In the illustrated embodiment, the data in at least one of these subordinate buffers is caused to be transmitted over the network link 130 to the other device 120. More specifically, the data is provided to the network interface 230, from which it is transmitted to the network interface 280. Postprocessing can then be carried out remotely, e.g., in the GPU 270. Then, the postprocessed data is caused to be transmitted back over the network link 130 to the subordinate buffer or buffers from whence it came. More specifically, the data is provided by the GPU 270 to the network interface 280, from which it is transmitted back to the network interface 230. Thus, postprocessing has been carried out in the GPU 270 instead of in the GPU 220. In an alternative embodiment, the GPU 220 may also carry out some preprocessing; however, the GPU 270 relieves the GPU 220 of at least some of the preprocessing. The data is written to the appropriate subordinate buffer or buffers, at which point it is typically displayed on the display 210.

In the embodiment of FIG. 2, the data transmitted over and back via the network link 130 depend upon the buffer or buffers being postprocessed. As those skilled in the pertinent art are aware, different postprocessing call for the data in different subordinate buffers to be used and/or modified. Accordingly, transmitting only the data that will be used and/or modified, and foregoing the transmission of data that plays no role in the postprocessing, decreases the bandwidth required of the network link 130 and saves power, which is particularly advantageous for the mobile device 110. Of course, all subordinate buffers could be transmitted. In one embodiment, all subordinate buffers are transmitted, but only those modified by postprocessing are transmitted back.

In the embodiment of FIG. 2, the data are compressed for transmission over and back via the network link 130. The data in the subordinate buffers are like video frames; thus, they can be compressed and decompressed just like video frames. In a specific embodiment, the data are compressed using a compression standard, such as the Institute of Electrical and Electronics Engineers (IEEE) H.264 compression standard. Other compression techniques fall within the broad scope of the invention. Further, the data need not be compressed.

FIG. 3 is a flow diagram of one embodiment of a method of increasing the graphics processing capability of a mobile device. The method begins in a start step 310. In a step 320, postprocessing is configured. In the illustrated embodiment, the user of the mobile device is able to configure whether postprocessing is to be carried out, what postprocessing is to be carried out and where the desired postprocessing is to be carried out (i.e. in the mobile device or in the other device). An app executing on the mobile device may enable the configuration.

In one embodiment, the postprocessing desired may depend upon the application generating the graphics to be postprocessed. For example, one game may benefit from blooming and SSAA, and another game may benefit from SSAO and recoloring.

In a step 330, graphics are rendered in the mobile device. The rendering may be carried out in a GPU or a CPU of the mobile device. Either way, the rendering produces rendered data. In a step 340, the rendered data is transmitted via a network link to another device. In a step 350, the rendered data is postprocessed, which transforms the rendered data into postprocessed data. In a step 360, the postprocessed data is transmitted via a network link back to the mobile device. The network link may be the same network link employed to transmit the rendered data to the other device, but is typically the same network link. In a step 370, the postprocessed data is displayed on the display of the mobile device. The method ends in an end step 380.

Those skilled in the art to which this application relates will appreciate that other and further additions, deletions, substitutions and modifications may be made to the described embodiments.

What is claimed is:

1. A system for increasing a graphics processing capability of a mobile device, comprising:
a graphics application programming interface (API) associated with said mobile device and operable to cause a graphics processing resource of said mobile device to render data generated by an application to yield rendered data; and
a network interface associated with said mobile device and operable to:
transmit at least some of said rendered data via a network link for postprocessing to yield postprocessed data, and
receive said postprocessed data for display on said mobile device.

2. The system as recited in claim 1 wherein said postprocessed data is compressed for transmission via said network link.

3. The system as recited in claim 1 wherein said graphics processing resource is a graphics processing unit.

4. The system as recited in claim 1 wherein a graphics processing unit of another device carries out said postprocessing.

5. The system as recited in claim 1 wherein only said rendered data pertaining to said postprocessing are transmitted via said network link.

6. The system as recited in claim 1 wherein said rendered data is stored in a subordinate buffer selected from the group consisting of:
a geometry buffer,
a depth buffer,
a color buffer, and
a stencil buffer.

7. The system as recited in claim 1 wherein said mobile device is selected from the group consisting of:
a smartphone,
a tablet, and
a handheld gaming console.

8. A method of increasing a graphics processing capability of a mobile device, comprising:
rendering data in said mobile device to yield rendered data;
transmitting at least some of said rendered data via a network link for postprocessing to yield postprocessed data;
receiving said postprocessed data via said network link; and
displaying an image on said mobile device using said postprocessed data.

9. The method as recited in claim 8 further comprising compressing said postprocessed data for transmission via said network link.

10. The method as recited in claim 8 wherein said rendering is carried out with a graphics processing unit of said mobile device.

11. The method as recited in claim 8 wherein said postprocessing is carried out with graphics processing unit of another device.

12. The method as recited in claim 8 further comprising transmitting only said rendered data pertaining to said postprocessing via said network link.

13. The method as recited in claim 8 further comprising storing said rendered data in a subordinate buffer selected from the group consisting of:
a geometry buffer,
a depth buffer,
a color buffer, and
a stencil buffer.

14. The method as recited in claim 8 wherein said mobile device is selected from the group consisting of:
a smartphone,
a tablet, and
a handheld gaming console.

15. A mobile device, comprising:
a display;
a central processing unit (CPU);
a graphics processing unit (GPU) having a graphics application programming interface (API) operable to cause said GPU to render data generated by an application executing on said CPU to yield rendered data; and
a network interface associated with said graphics API and operable to:
transmit at least some of said rendered data via a network link for postprocessing to yield postprocessed data, and
receive said postprocessed data for display on said display.

16. The mobile device as recited in claim 15 wherein said postprocessed data is compressed for transmission via said network link.

17. The mobile device as recited in claim 15 wherein said graphics processing resource is a graphics processing unit.

18. The mobile device as recited in claim 15 wherein a GPU of another device carries out said postprocessing.

19. The mobile device as recited in claim 15 wherein only said rendered data pertaining to said postprocessing are transmitted via said network link.

20. The mobile device as recited in claim 15 wherein said mobile device is selected from the group consisting of:
a smartphone,
a tablet, and
a handheld gaming console.
